(19) United States
(12) Patent Application Publication
(10) Pub. No.: US 2026/0286465 A1
(43) Pub. Date: Sep. 24, 2026

(54) SMELTING FURNACE ARRANGEMENT

(71) Applicant: Metso Metals Oy, Espoo (FI)

(72) Inventors: Peter BJÖRKLUND, Espoo (FI); Markku LAHTINEN, Espoo (FI); Ilpo LOIKKANEN, Espoo (FI)

(21) Appl. No.: 19/475,252

(22) PCT Filed: Apr. 14, 2023
(86) PCT No.: PCT/FI2023/050212

§ 371 Date: Oct. 14, 2025

(51) Int. Cl. C22B 15/00

(52) U.S. Cl. CPC C22B 15/005; C22B 15/0054

(57) ABSTRACT

A smelting furnace arrangement comprises a first smelting furnace and a second smelting furnace. The first and second smelting furnaces comprise a reaction shaft end comprising a reaction shaft end wall and an uptake shaft end comprising an uptake shaft end wall. The reaction shaft end wall of the first smelting furnace is located at a distance from the reaction shaft end wall of the second smelting furnace. The distance is less than 20 m.

### FIELD OF THE INVENTION

The present invention relates to a smelting furnace arrangement. The present invention also relates to a method for using said smelting furnace arrangement.

### BACKGROUND OF THE INVENTION

Conventional processes for the conversion of copper containing concentrate typically comprise flash smelting and flash converting.

The process usually involves oxidation of the concentrate in a flash smelting furnace (FSF) to produce matte. The matte may then be fed to a flash converting furnace (FCF), where the matte is further oxidised to produce blister. The furnaces are typically placed in different building sections and, thus, quite far away from each other.

In the process, slag is formed both in the FSF and FCF. The slag typically comprises a significant amount of metals and should thus be recycled back to one or several furnaces for further processing in order to improve the yield of the process.

Also, dust, material to be reverted, solidified matte and solidified slag is formed in the off-gas lines, the launders or ladles and the furnaces. These components also comprise a significant amount of metals and should thus be recycled back to one or several furnaces for further processing in order to improve the yield of the process. Additionally, the dust comprises mostly oxides or sulphates which results in reactions in the furnaces that are endothermic.

The recycling of slag consumes a lot of resources as the slag is typically granulated by water sprays, stored in bins and fed into a dryer before being fed back into the furnaces. The granulation of the slag consumes a lot of water, since water is mainly used to cool down the slag and to break it into smaller particles. This causes steaming losses and particle contamination of the granulation water, which requires further treatment before reuse of the water is possible. When the slag is fed to the furnace to which it is to be recycled, energy is required to heat up the slag again to a temperature sufficient to melt the slag. The slag granulation water needs to be cooled by a secondary cooling water circuit, which further consumes energy and water.

Further, it is important that the recycled slag is mixed well with the suspension in the furnaces in order to allow as much exchange of metals from the slag to the product of the furnaces.

The recycling of dust, material to be reverted, solidified matte and solidified slag is burdensome as the distance between the furnaces are long. The material must be transported between building sections and may be contaminated on the way.

Another drawback with conventional smelting furnace arrangements is that the feeding environment for fluxing agents, dust, material to be reverted, solidified matte, solidified slag and concentrate is dusty, due to the dryness and fineness of the material, and thus an HSE issue. Since the furnaces are in different building sections and far away from each other, several feeding stations are needed.

Also, in conventional processes, the dust from several furnaces (i.e. an FSF and an FCF) is fed to a bin from which it may be recycled back to the furnaces. Consequently, the quality and composition of the dust in the bin is unknown as for example FSF and FCF dust differ from each other a lot. This leads to a lack of control of the dust recycling system. This is also a problem in a shutdown situation as the dust is typically dumped to the bin where it solidifies.

As such there is a need for improved furnace arrangements and methods that allow recycling of molten slag between the furnaces and that allow good mixing of the slag and the product of the furnace. There is also a need for improved furnace arrangements and methods that allow easy and safe recycling and/or feeding of dust, fluxing agents, material to be reverted, solidified matte, solidified slag and concentrate to the furnaces. Specifically, the dust recycling should be improved in order to obtain better control over the recycling and an improved system for shut down situations.

### SUMMARY

According to a first aspect, a smelting furnace arrangement is provided, comprising a first smelting furnace (15a) and a second smelting furnace (15b), wherein the first and second smelting furnaces (15a, 15b) comprise a reaction shaft end comprising a reaction shaft end wall (16a, 16b) and an uptake shaft end comprising an uptake shaft end wall (21a, 21b), wherein the reaction shaft end wall (16a) of the first smelting furnace (15a) is located at a distance (X) from the reaction shaft end wall (16b) of the second smelting furnace (15b), and wherein the distance (X) is less than 20 m.

According to a second aspect, a method for producing blister in a suspension smelting furnace arrangement is provided, comprising:
i. feeding concentrate to a first smelting furnace (15a),
iii. forming matte in the first smelting furnace (15a),
iv. transporting at least a part of the matte from the first smelting furnace (15a) to a second smelting furnace (15b) via a second transport means (123), and
vi. forming blister in the second smelting furnace (15b),
wherein the first and second smelting furnaces (15a, 15b) comprise a reaction shaft end comprising a reaction shaft end wall (16a, 16b) and an uptake shaft end comprising an uptake shaft end wall (21a, 21b), wherein the reaction shaft end wall (16a) of the first smelting furnace (15a) is located at a distance (X) from the reaction shaft end wall (16b) of the second smelting furnace (15b), and wherein the distance (X) is less than 20 m.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a schematic illustration of a smelting furnace arrangement according to the first embodiment of the invention.

FIG. 2 is a schematic illustration of a smelting furnace arrangement according to the first embodiment of the invention, wherein the first transport means (222) extends from the first taphole (111b) of the second smelting furnace (15b) to the feeding means (120a) of the first smelting furnace (15a) and the second transport means (123) extend from the second taphole (112a) of the first smelting furnace (15a) to the burner for burning concentrate or a matte (2b) of the second smelting furnace (15b).

FIG. 3 is a schematic illustration of a smelting furnace arrangement according to the first embodiment of the invention, wherein solids (24a, 24b) are recycled from the uptake shaft (10b) of the second smelting furnace (15b) to the first smelting furnace (15a) and from the uptake shaft (10a) of the first smelting furnace (15a) to the second smelting furnace (15b).

FIG. 4 is a schematic illustration of a smelting furnace arrangement according to the first embodiment of the invention, wherein the first and second smelting furnace (15a, 15b) comprise common feeding means (18, 17a, 17b) for feeding fluxing agents, solidified matte, solidified slag and/or material to be reverted.

### DETAILED DESCRIPTION

It is obvious to a person skilled in the art that with the advancement of technology, the basic idea of the invention may be implemented in various ways. The invention and its embodiments are thus not limited to the examples described below, instead they may vary within the scope of the claims.

### Smelting Furnace Arrangement

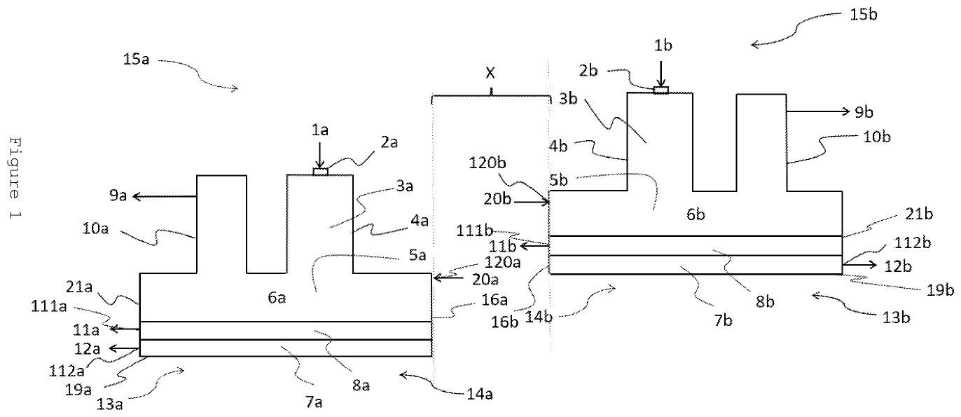

According to a first aspect and as illustrated in FIG. 1, a smelting furnace arrangement is provided, comprising a first smelting furnace (15a) and a second smelting furnace (15b), wherein the first and second smelting furnaces (15a, 15b) comprise a reaction shaft end comprising a reaction shaft end wall (16a, 16b) and an uptake shaft end comprising an uptake shaft end wall (21a, 21b), wherein the reaction shaft end wall (16a) of the first smelting furnace (15a) is located at a distance (X) from the reaction shaft end wall (16b) of the second smelting furnace (15b), and wherein the distance (X) is less than 20 m.

The distance (X) may be 2 to 20 m, or 4 to 17 m, or 7 to 13 m, or 9 to 11 m.

The first smelting furnace (15a) may be located vertically below the second smelting furnace (15b), for example 1 to 7 m, or 2 to 5 m, or 3 to 4 m, or 1 m below.

The inventors have found that the above distance (X) allows material to be fed between the smelting furnaces in an efficient manner, as further explained below. The vertical distance of the furnaces has the added utility that gravity may be used for conveying material between the furnaces.

The first smelting furnace (15a) according to the first aspect may be a suspension smelting furnace and/or the second smelting furnace (15b) according to the first aspect may be a suspension smelting furnace.

The first suspension smelting furnace (15a) may be a flash smelting furnace (FSF) and the second suspension smelting furnace (15b) may be a flash converting furnace (FCF).

The first and second smelting furnaces (15a, 15b) may comprise:
i. a reaction shaft (4a, 4b) provided with a burner for burning concentrate or a matte and feeding concentrate or matte (2a, 2b), into the reaction shaft (4a, 4b) to form a jet of an at least partially oxidised suspension (3a, 3b) in the reaction shaft (4a, 4b),
ii. a settler (19a, 19b) in communication with a lower end of the reaction shaft (4a, 4b), wherein the settler (19a, 19b) has an inner space (6a, 6b) and a reaction shaft end wall (16a, 16b) at one end of the settler (19a, 19b) and an uptake shaft end wall (21a, 21b) at the opposite end of the settler (19a, 19b) and a landing zone (5a, 5b) for the jet of oxidised suspension (3a, 3b) in the inner space (6a, 6b) of the settler (19a, 19b) below the lower end of the reaction shaft (4a, 4b), and wherein the settler (19a, 19b) extends in two opposite directions from the landing zone (5a, 5b) so that the settler (19a, 19b) comprises a reaction shaft settler part (14a, 14b) on the reaction shaft (4a, 4b) side of the landing zone (5a, 5b) and an uptake shaft settler part (13a, 13b) on an opposite uptake shaft (10a, 10b) side of the landing zone (5a, 5b), and wherein the settler (19a, 19b) is configured to receive the at least partially oxidised suspension (3a, 3b) from the reaction shaft (4a, 4b) at the landing zone (5a, 5b) and to form a layer of matte or blister (7a, 7b) and a layer of slag (8a, 8b) on top of the layer of matte or blister (7a, 7b) in the inner space (6a, 6b) of the settler (19a, 19b),
iii. feeding means (120a, 120b) for feeding a molten material (20a, 20b) to the smelting furnace, wherein the feeding means (120a, 120b) is in communication with the settler (19a, 19b) in the reaction shaft settler part (14a, 14b) above the layer of slag (8a, 8b) when in use, iv. a first taphole (111a, 111b) arranged in the reaction shaft settler part (14a, 14b) or the uptake shaft settle part (13a, 13b) for discharging slag (11a, 11b) from the layer of slag (8a, 8b) in the inner space (6a, 6b) of the settler (19a, 19b), and
v. a second taphole (112a, 112b) arranged in the uptake shaft settler part (13a, 13b) for discharging matte or blister (12a, 12b) from the layer of matte or blister (7a, 7b) in the inner space (6a, 6b) of the settler (19a, 19b),
wherein the first taphole (111a, 111b) is arranged in the vertical direction at a level above the second tap-hole (112a, 112b).

Prior to feeding the concentrate or matte to the concentrate or matte burner (2a, 2b), it may be dried to a moisture content of 0 to 1%, preferably in a steam or rotary dryer or a matte grinding mill. This consumes steam or fuel in the form of natural gas or fuel oil.

The burner for burning concentrate or matte (2a, 2b) may be designed to symmetrically mix the feed and an oxygen enriched gas. The oxygen enriched gas may be air or oxygen-enriched air. In one embodiment, the reaction shaft (4a, 4b) provides means for delivering natural gas or fuel oil to the reaction shaft fuel burner(s) (2a, 2b). The natural gas or fuel oil provides additional heat when burned in the reaction shaft (4a, 4b), which facilitates the melting of the concentrate or matte fed thereto.

If the smelting furnace is an FSF, concentrate may be fed to the furnace (1a). If the smelting furnace is an FCF matte may be fed to the furnace (1b). Similarly, if the smelting furnace is an FSF, the settler (19a) may be configured to receive the at least partially oxidised suspension (3a) from the reaction shaft (4a) at the landing zone (5a) and to form a layer of matte (7a) and a layer of slag (8a) on top of the layer of matte (7a) in the inner space (6a) of the settler (19a). To the contrary, if the smelting furnace is an FCF, the settler (19b) may be configured to receive the at least partially oxidised suspension (3b) from the reaction shaft (4b) at the landing zone (5b) and to form a layer of blister (7b) and a layer of slag (8b) on top of the layer of blister (7b) in the inner space (6b) of the settler (19b).

### The Jet of the at Least Partially Oxidised Suspension

(3a, 3b) may be heated to a temperature sufficient to completely melt the concentrate or matte. The jet of the at least partially oxidised suspension (3a, 3b) may be heated to a temperature of 1100 to 1600° C., or 1250 to 1450° C., for example 1300° C. It has been found that heating the jet of the at least partially oxidised (3a, 3b) suspension to these temperatures ensures that the suspension is completely melted, and that the viscosity of the slag is suitable for separation of the two phases, i.e. slag and matte or blister.

Concentrate may refer to ore concentrate that is the product of metal ore mines. Specifically, concentrate may comprise copper concentrate comprising copper and iron in the form of copper and iron sulphides. The exact composition of the concentrate may vary depending on the geographical origin of the metal ore. In one embodiment, the concentrate is fed to the reaction shaft in a solid state as fine granules.

At least partially oxidised may refer to at least 60 wt.-%, 70 wt.-%, 80 wt.-%, 90 wt.-% or 100 wt.-% of the iron present in the furnace feed being in an oxidized state. An oxidised state may refer to the iron elements being in the form of oxidic compounds and the wt.-% refers to the percentage of the iron present in the furnace feed being in an oxidized state. It is particularly advantageous to form a jet wherein at least 70 wt.-% of the iron is in an oxidised state because this reduces the oxidation requirement, which otherwise would be performed further down the process line.

The term “in communication with” refers to an open space being available between the discussed components such that the components share the open space, and such that material can be freely exchanged between the components.

The settler (19a, 19b) may further comprise two side walls, a bottom and a roof extending between the reaction shaft and uptake shaft end wall (16a, 16b, 21a, 21b) structures. The reaction shaft and uptake shaft end wall (16a, 16b, 21a, 21b) structures may have the form of a square or rectangle such that the side walls, bottom and roof extend from the peripheries of one end wall to the peripheries of the other end wall, and thereby form a closed space between the end walls, bottom, roof and sidewalls. The reaction shaft (4a, 4b) may be located in the roof and the layer of slag and matte or blister (8a, 8b, 7a, 7b) may rest on the bottom when the device is in use. The bottom may slope downwardly for example in an inclined and/or curved manner towards the first and/or second taphole (111a, 112a, 112b) for facilitating the discharge of slag and/or matte or blister (11a, 12a, 12b).

In one embodiment, the reaction shaft end wall (16a) of the first smelting furnace (15a) faces the reaction shaft end wall (16b) of the second smelting furnace (15b).

The inner space (6a, 6b) of the settler (19a, 19b) is in one embodiment in communication with the lower end of the reaction shaft (4a, 4b) at a point of the settler (19a, 19b) that is closer to the middle of the settler (19a, 19b) than one of the ends of the settler (19a, 19b).

The settler (19a, 19b) may have an elongated configuration. In one embodiment, the settler (19a, 19b) has the shape of a cuboid. The settler may be 12 to 30 m long, 4 to 12 m wide and 1 to 3 m high.

The inventors have found that the configuration of the settler (19a, 19b) has a number of advantages. For example, the uptake shaft end (13a, 13b) of the settler (19a, 19b) has a lower dust content, since gas and dust are sucked together with off-gases through the gas phase of the uptake shaft settler end (13a, 13b) towards an uptake shaft (10a, 10b). This lower dust content creates a relatively dust free atmosphere for the feeding means (12a, 120b). This relatively dust free atmosphere is beneficial for minimising dust emissions from the furnace through the feeding means (120a, 120b). Further, the reaction shaft part (14a, 14b) of the settler (19a, 19b) has a lower pressure than the uptake shaft settler part (13a, 13b), since gas and dust are sucked together with the off-gases through the gas phase of the settler part towards the uptake shaft (10a, 10b). This lower pressure is beneficial for minimizing SO₂ emissions from the furnace through the feeding means.

The smelting furnaces (15a, 15b) may comprise a partition baffle for preventing oxidised dust created in the smelting furnace from entering at least a section of the reaction shaft settler part (14a, 14b). The partition baffle may extend from the roof of the reaction shaft settler part (14a, 14b) downwards into the reaction shaft settler part (14a, 14b). The partition baffle may further minimise the dust content and lower the pressure in the uptake shaft settler part (13a, 13b).

As an example, in a traditional suspension smelting furnace, such as in a suspension smelting furnace as disclosed in the Finnish patent no. 22694, the end of the settler wall that is closer to the reaction shaft wears a lot, because of the closeness of the reaction shaft, which is the hottest part of the settler. In a smelting furnace according to the invention, the reaction shaft end wall (16a, 16b) of the settler (19a, 19b) is located at a distance from this hottest part of the settler (19a, 19b) and thus wear will not be an issue.

In one embodiment, the smelting furnaces comprises reducing agent feeding means for feeding reducing agent(s) into at least one of the layers of matte or blister and the layer of slag (7a, 7b, 8a, 8b) in the reaction shaft settler part (14a, 14b). The reaction shaft settler part (14a, 14b) may also comprise a burner for creating a reducing atmosphere in at least a section of the reaction shaft settler part (14a, 14b), for example by consuming oxygen present in the reaction shaft settler part (14a, 14b) in the burning process. This further reduces the oxygen content in the reaction shaft settler part.

The feeding means (120a, 120b) may be located closer to the reaction shaft end wall structure (16a, 16b) in the reaction shaft settler part (14a, 14b) than to the middle of the settler (19a, 19b). In one embodiment, the feeding means (120a, 120b) is located in the reaction shaft end wall (16a, 16b) of the smelting furnaces. Alternatively, the feeding means (120a, 120b) is located in the roof the settler (19a, 19b) or in the side wall of the settler (19a, 19b) in the reaction shaft end of the settler (14 a, 14 b) and at a distance of less than 2 m from the end wall (16a, 16b), for example the feeding means may be at a distance of 0.2 to 2 m, or 0.4 to 1.8 m, or 0.6 to 1.6 m from the end wall structure.

The feeding means (120a, 120b) may comprise a launder for guiding the molten material extending from the end wall structure (16a, 16b) or side wall or roof of the settler (19a, 19b) into the inner space of the settler (6a, 6b). The lauder can guide the molten material such that the molten material is not in direct contact with the end wall structure or side wall or roof of the settler (19a, 19b). In this way, the inner structure of the settler does not wear due to a constant contact with freshly introduced hot molten material.

The first taphole (111b) may be located in the reaction shaft end wall (16b) if the smelting furnace is an FCF. Alternatively, the first taphole (111b) may be located in the sidewall of the settler (19b) in the reaction shaft settler part (14 b) at a distance of less than 2 m from the end wall (16b). These locations are beneficial as solid copper scrap may be fed to the FCF, between the reaction shaft (4a) and uptake shaft (10b), without disturbing the process control. Since the copper scrap is in solid form, discharging slag from the vicinity of the solid feeding may cause fluctuation copper content of the slag and increased slag discharging difficulties. Discharging FCF liquid slag from the FCF reaction shaft end (14b) forces the scrap comprising copper to move through the suspension coming from the reaction shaft (4b), which forces mixing with the rest of the melt.

Scrap may refer to material comprising copper originating from downstream processes.

The first taphole (111a) may be located in the uptake shaft end wall (21a) if the smelting furnace is an FSF. Alternatively, the first taphole (111a) may be located in the sidewall of the settler (19a) in the uptake shaft settler part (13 a) at a distance of less than 2 m from the end wall (21a).

The arrangement according to the first aspect may comprise a first transport means (222) between the first and the second smelting furnaces (15a, 15b) for trans-porting a first material (22) from the second smelting furnace (15b) to the first smelting furnace (15a), preferably wherein the first material (22) is transported as a melt.

The arrangement according to the first aspect may comprise a second transport means (123) between the first and the second smelting furnaces (15a, 15b) for trans-porting a second material (23) from the first smelting furnace (15a) to the second smelting furnace (15b), preferably wherein the second material (23) is transported as granules.

The first material (22) according to the first aspect may comprise slag and/or the second material (23) may comprise matte.

In one embodiment, the first material (22) comprises at least 60 wt.-%, or at least 80 wt.-% or 100 wt.-% slag. In one embodiment, the second material (23) comprises at least 60 wt.-%, or at least 80 wt.-% or 100 wt.-% matte.

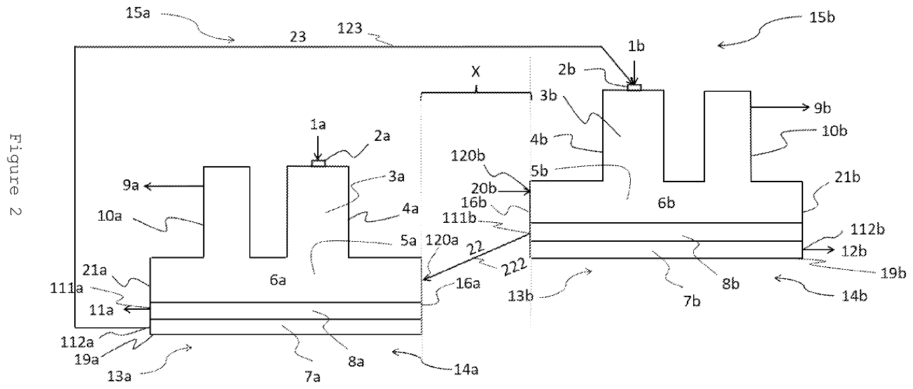

As illustrated in FIG. 2, the first transport means (222) may extend from the first taphole (111b) of the second smelting furnace (15b) to the feeding means (120a) of the first smelting furnace (120a). The second transport means (123) may extend from the second taphole (112a) of the first smelting furnace (15a) to the burner for burning concentrate or a matte (2b) of the second smelting furnace (15a).

In one embodiment, the first transport means (222) comprises a launder for introducing the molten material continuously or batchwise. Alternatively, the first transport means (222) may comprise a pot or a ladle for feeding the molten material batchwise. The molten material may be fed to the first smelting furnace (15a) through gravity. This has the added utility that no energy is required for conveying the molten material. The temperature of the molten material is in one embodiment between 1000 and 1450° C., or between 1220 and 1320° C., for example 1270° C. It has been found that these temperatures are high enough to maintain e.g. slag as the molten material in a liquid form but low enough not to damage the equipment used.

In one embodiment, the matte is fed to the reaction shaft (4b) of the second smelting furnace (15b) in a solid state as fine granules. As such, it may be required to cool down and granulate the matte originating from the first smelting furnace (15a) prior to feeding the matte to the second smelting furnace (15b). The matte is usually cooled and granulated by water sprays, crushed into fine granules using a grinding mill, stored in bins and fed into a dryer before being fed back into the furnaces. The matte may be transported pneumatically to the reaction shaft of the second smelting furnace (15b).

The grinding mill may use natural gas or steam as fuel. The furnace arrangement makes it possible to locate the matte discharge in the uptake shaft end (13a) of the first smelting furnace (15a). The location of the matte taphole(s) (112a) in the uptake shaft end (13a) of the furnace is beneficial because it forces the matte to move all the way through the length of the furnace, which brings heat also to the uptake shaft (10a) of the furnace (15a), which reduces melt solidification at the uptake shaft (10a) of the furnace (15a).

The location of the matte taphole(s) (112a) in the uptake shaft end (13a) of the FSF is also beneficial because the distance from the reaction shaft (4a) to the matte taphole(s) (112a) is the same for each taphole (if several tapholes exists), which creates a more even copper concentration in the discharged matte, which is beneficial for process control in the second furnace.

It has been found that when molten material, and particularly slag, is fed to the settler (19a) above the layer of slag (8a) and in the reaction shaft settler part (14a) and the slag is tapped from the uptake shaft end wall (21a) or uptake shaft end (13a) side wall, the slag is forced to move through the suspension coming from the reaction shaft (4a). The reason being that the reaction shaft product is discharged from the furnace from the opposite side of the settler compared to the feeding means. As a result, the molten material, e.g. slag, mixes with the suspension, which contributes to the oxidation of the melt and creates a uniform mixture, which has a positive effect on the yield of metals recovered from the process.

It has also been found that the furnace arrangement as disclosed herein is particularly beneficial. Namely because molten material, for example slag, may be fed in a molten form between the furnaces (15a, 15b) without the need to consume energy for heating the material during transport. It has also been found that the transport of both the first and second material (22, 23) is facilitated due to the proximity of the furnaces. Also, due to the inventive arrangement, the furnaces can be placed in the same building section, which has not been possible with conventional smelting furnace arrangements.

The slag according to the first aspect may comprise copper oxides, iron oxides and fluxing agents.

The slag may comprise 5 to 30 wt.-%, or 10 to 25 wt.-%, or 15 to 20 wt.-% copper.

The fluxing agents may be compounds comprising silica and/or calcium. In one embodiment, silicon dioxide is used as fluxing agents when the smelting furnace is an FSF and lime, calcium carbonate or calcium oxide is used as fluxing agents when the smelting furnace is an FCF. The fluxing agents may be fed to the reaction shaft (4a, 4b). The fluxing agents decrease the viscosity of the slag which facilitates the discharge of slag from the smelting furnaces and minimises the formation of material to be reverted. In one embodiment, the weight ratio of iron to silicon dioxide in the FSF slag is 0.9 to 2.0, or 0.7 to 1.8, for example 1.0 to 1.5. Silicon dioxide, lime, calcium carbonate or calcium oxide is particularly useful as fluxing agents because they are relatively inexpensive while still giving the desired result of lowering the viscosity of the slag.

The matte according to the first aspect may comprise copper matte.

Matte may refer to the product of an FSF to which concentrate and oxygen has been fed. Specifically, the copper matte may comprise iron and copper sulphides and the copper content of the matte may be 40 to 75 wt.-%, or 45 to 70 wt.-%, or 50 to 65 wt.-%.

The arrangement according to the first aspect may comprise solid transport means (124a, 124b) between the first and the second smelting furnaces (15a, 15b) for transporting solid material (24a, 24b) from the first smelting furnace (15a) to the second smelting furnace (15b) and/or from the second smelting furnace (15b) to the first smelting furnace (15a).

The solid material (24a, 24b) according to the first aspect may comprise dust.

The smelting furnaces (15a, 15b) may comprise an uptake shaft (10a, 10b) for leading process gases (9a, 9b) from the smelting furnace via the uptake shaft (10a, 10b), wherein the uptake shaft (10a, 10b) has a lower end in communication with the settler (19a, 19b) in the uptake shaft settler part (13a, 13b).

The process gases may comprise sulphur dioxide, carbon dioxide, water, metal containing vapours, nitrogen and some reaction shaft product in the form of unsettled suspension particles. Specifically, the unsettled suspension particles, which are dust, may comprise copper compounds.

The process gases may be led to a heat exchanger for cooling the process gases followed by gas and solid separation. The heat exchanger is typically but not necessarily a steam boiler, which cools the gases by evaporating water into steam. Dust may be separated from the gas in the gas and solid separation. The gas and solid separator is in one embodiment an electrostatic precipitator, which collects and separates the dust from the gases. In one embodiment, the dust is recycled back to the burner of the reaction shaft of the smelting furnace. The heat from the cooling may be recovered and used as electricity.

The dust may be recycled from the uptake shaft (10a, 10b) of the same smelting furnace (an FSF or FCF) via the heat exchanger and solid separation to the burner (2a, 2b) of the same smelting furnace (15a, 15b) or from another smelting furnace (15a, 15b) to the burner (2a, 2b) of the smelting furnace (15a, 15b).

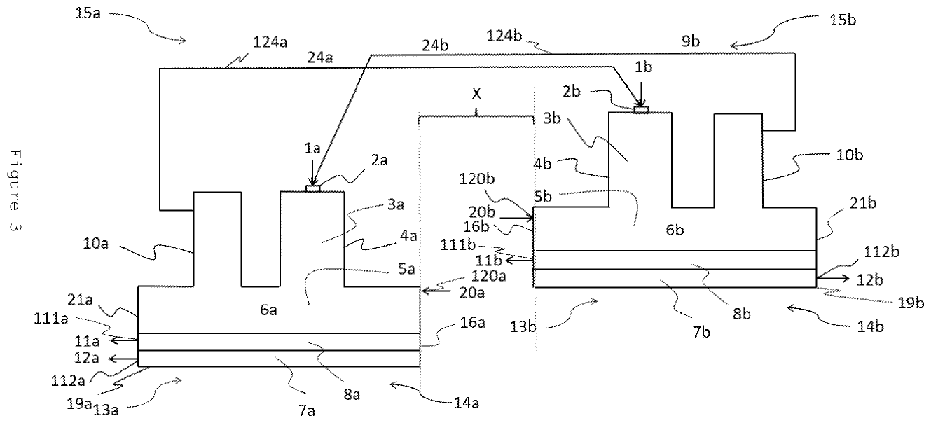

For example, the dust may be recycled from the uptake shaft (10b) of an FCF, via the heat exchanger and solid separation to the burner (la) of an FSF and/or from the uptake shaft (10a) of an FSF, via the heat exchanger and solid separation to the burner (2b) of an FCF. This is illustrated in FIG. 3.

In one embodiment, the dust from the first and second smelting furnace (15a, 15b) are fed to separate dust bins, from which the dust may be fed to the first and/or the second smelting furnace (15a, 15b).

Recycling the dust improves the yield of the copper in the end product as some copper is still present in the dust. Also, the inventors have found that it is especially beneficial to recycle the dust between the furnaces as described above because the dust from different furnaces have different compositions and qualities. For example, it is common practice to recycle a part of the second furnace dust to the first furnace. However, the process control is very sensitive to the exact amount of dust from second furnace, since the chemical analysis between the dusts from the two furnaces are different. As such, the flexibility of directing the dust between the furnaces improves the control of the process.

Also, the inventors have found that it is especially beneficial to recycle the dust between the furnaces as described above because it removes dust hardening issues during furnace shutdowns. For example, in an unplanned event of one furnace shutdown, the dust bins can be emptied to the other furnace.

It is also beneficial that the dust feeding means are located proximal to each other. The feeding means environment is dusty and by locating the feeding means in the same area, only one dusty environment for both furnaces instead of several is needed. The dusty environment is a health, safety and environment hazard.

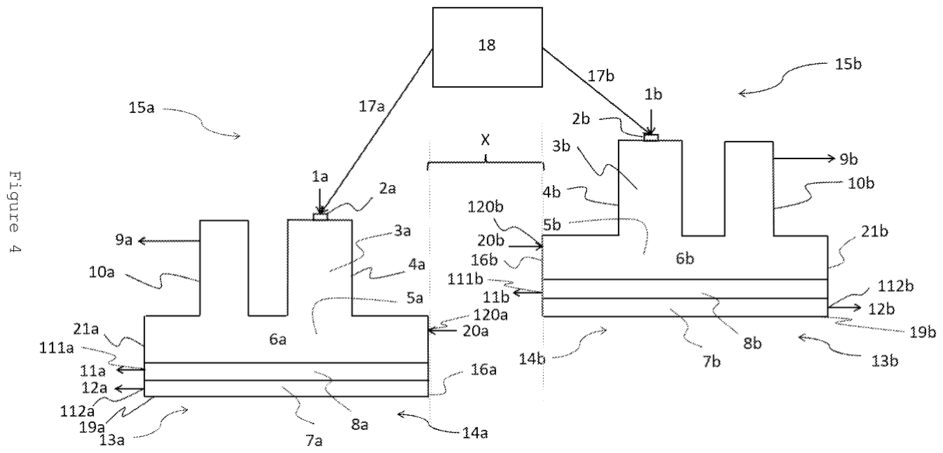

The arrangement according to the first aspect may comprise feeding means (18, 17a, 17b) for feeding fluxing agents, solidified matte, solidified slag and/or material to be reverted to the first and/or the second smelting furnace (15a, 15b), wherein the feeding means (18, 17a, 17b) is the same for the first and the second smelting furnaces (15a, 15b). This is illustrated in FIG. 4. The feeding means (18, 17a, 17b) for feeding fluxing agents, solidified matte, solidified slag and/or material to be reverted may be suitable for feeding the material to the first and the second smelting furnaces simultaneously. The feeding means (18, 17a, 17b) for feeding fluxing agents, solidified matte, solidified slag and/or material to be reverted may be suitable for feeding the material to the first and the second smelting furnaces separately.

In one embodiment, also concentrate (1a) and matte (1b) is fed to the first or second smelting furnace (15a, 15b) through the common feeding means (18, 17a, 17b).

Material to be reverted may be recycled from the output of the smelting furnace (15a, 15b) to the input of the same smelting furnace (15a, 15b) or from another smelting furnace (15a, 15b) to the input of the smelting furnace (15a, 15b). For example, the material to be reverted may be recycled between an FSF and an FCF. Material to be reverted may refer to any reaction shaft product that has accumulated in the off-gas lines, the launders or ladles and the furnaces. The material to be reverted may be fed to the smelting furnaces by mixing it with the main feed or through a separate feeder.

In one embodiment, solidified slag refers to slag produced in a smelting furnace (15a, 15b), which has been discharged via the first taphole (111a, 111b) and solidified. The slag may be discharged from an FCF and recycled to an FSF or vice versa, for example. The slag may also be discharged from the same smelting furnace (15a, 15b) to which it is recycled. The slag may be solidified and granulated using water and/or air and/or nitrogen prior to being fed to the smelting furnaces (15a, 15b).

Solidified slag and material to be reverted usually comprise a significant amount of metals and by recycling these to the smelting furnaces the remaining metals may be recovered.

Alternatively, no fluxing agents are fed to the burner (2a, 2b) when the smelting furnace is an FCF. The copper present in the matte may be oxidised to convert a part of the copper into copper oxide. The presence of copper oxide in the slag assists in liquefying the slag. It may be desirable to oxidise the copper to attain at least 30 wt.-% of oxidised copper in the slag of the total weight of the slag. The desired ratio may be achieved by injecting the reaction gas containing oxygen through the burner (2a, 2b) to achieve a partial pressure (pO₂) of from 1 to 100 Pa, or from 2 to 70 Pa, or from 10 to 30 Pa. In one embodiment, the concentration of oxidised copper in the slag is from 30 to 90 wt.-%, or from 35 to 70 wt.-%, or from 40 to 60 wt.-%, of the total weight of the slag. Accordingly, it may be possible to convert copper containing material to blister copper without use of conventional fluxing agents. The desired temperature of the burner (2a, 2b) may be dependent on the desired concentration of oxidised copper in the converter slag. The temperature is typically at least 1200° C. to ensure that the slag is in a molten phase and to attain acceptable yield of copper. When lower concentration of copper oxide is present in the slag a higher temperature may be required. The temperature is for example from 1220 to 1450° C., or from 1250 to 1400, or from 1300 to 1380° C.

The feeding means (18, 17a, 17b) may comprise several bins (18) and launders or pipes (17a, 17b).

The inventors have found that it is beneficial to feed the above materials via the same feeding means (18, 17a, 17b) to either or to both of the furnaces (15a, 15b). For example, utilising the same feeding means (18, 17a, 17b) for material to be reverted from the second smelting furnace gives additional accuracy for the heat balance control, since the type of reverted material is always known, whereas the current state-of-the art mixes the different reverted materials from both smelting furnaces before the feeding means (18, 17a, 17b), which then creates an unknown mixture of reverted material discharged from the feeding means (18, 17a, 17b) to the furnace. Specifically, feeding material to be reverted creates an endothermic reaction in the furnace and by adjusting the amount of known reverted material to the different furnaces allows a more accurate heat balance control in both furnaces.

Further, the inventors have found that it is beneficial to feed the above materials from the same feeding areas to the furnaces (15a, 15b). For example, because the feeding environment is dusty and by locating the feeding means in the same area, only one dusty environment for both furnaces (15a, 15b) instead of several is needed. The dusty environment is a health, safety and environment hazard. The arrangement and proximity of the furnaces (15a, 15b) allow common feeding means to be used.

### Method

The description related to the smelting furnace arrangement above apply to the smelting furnace in the description related to the method below.

According to a second aspect, a method for producing blister in a suspension smelting furnace arrangement is provided, comprising:
i. feeding concentrate (la) to a first smelting furnace (15a),
iii. forming matte in the first smelting furnace (15a),
iv. transporting at least a part of the matte from the first smelting furnace (15a) to a second smelting furnace (15b) via a second transport means (123), and
vi. forming blister in the second smelting furnace (15b),
wherein the first and second smelting furnaces (15a, 15b) comprise a reaction shaft end comprising a reaction shaft end wall (16a, 16b) and an uptake shaft end comprising an uptake shaft end wall (21a, 21b), wherein the reaction shaft end wall (16a) of the first smelting furnace (15a) is located at a distance (X) from the reaction shaft end wall (16b) of the second smelting furnace (15b), and wherein the distance (X) less than 20 m.

The first smelting furnace (15a) according to the second aspect may be a suspension smelting furnace and/or the second smelting furnace (15b) according to the second aspect may be a suspension smelting furnace.

The matte according to the second aspect may comprise iron and copper sulphides.

The method according to the second aspect may further comprise vii. transporting slag from the second smelting furnace (15b) to the first smelting furnace (15a), preferably wherein the slag is transported as a melt via a first transport means (222).

The slag according to the second aspect may comprise copper oxides, iron oxides and fluxing agents.

The method according to the second aspect may further comprise vii. or viii. transporting solids (24a, 24b) from the second suspension smelting furnace (15b) to the first suspension smelting furnace (15a) and/or from the first suspension smelting furnace (15a) to the second suspension smelting furnace (15b), wherein the solids (24a, 24b) are transported via solid transport means (124a, 124b).

The solids (24a, 24b) according to the second aspect may comprise dust.

The blister according to the second aspect may comprise copper blister.

The blister may comprise at least 60 wt.-%, or 80wt.-%, or 100 wt.-% copper blister. The copper blister may comprise copper, iron and sulphur. In one embodiment, the blister comprises 96-99.5 wt.-% copper and 0.01-0.5 wt.-% iron.

The method according to the second aspect may further comprise feeding fluxing agents, solidified matte, solidified slag and/or material to be reverted to the first and/or the second smelting furnace (15a, 15b) through feeding means (18, 17a, 17b), wherein the feeding means (18, 17a, 17b) is the same for the first and the second smelting furnaces (15a, 15b).

1. A smelting furnace arrangement, comprising a first smelting furnace and a second smelting furnace, wherein the first and second smelting furnaces comprise a reaction shaft end comprising a reaction shaft end wall and an uptake shaft end comprising an uptake shaft end wall, wherein the reaction shaft end wall of the first smelting furnace is located at a distance from the reaction shaft end wall of the second smelting furnace, and wherein the distance is less than 20 m.

2. The smelting furnace arrangement according to claim 1, wherein the first smelting furnace is a suspension smelting furnace and/or wherein the second smelting furnace is a suspension smelting furnace.

3. The smelting furnace arrangement according to claim 1, wherein the arrangement comprises a first transport means between the first and the second smelting furnaces for transporting a first material from the second smelting furnace to the first smelting furnace, preferably wherein the first material is transported as a melt.

4. The smelting furnace arrangement according to claim 3, wherein the arrangement comprises a second transport means between the first and the second smelting furnaces for transporting a second material from the first smelting furnace to the second smelting furnace, preferably wherein the second material is transported as granules.

5. The smelting furnace arrangement according to claim 4, wherein the first material comprises slag and/or the second material comprises matte.

6. The smelting furnace arrangement according to claim 5, wherein the slag comprises copper oxides, iron oxides and fluxing agents.

7. The smelting furnace arrangement according to claim 5, wherein the matte comprises copper matte.

8. The smelting furnace arrangement according to claim 1, wherein the arrangement comprises solid transport means between the first and the second smelting furnace for transporting solid material from the first smelting furnace to the second smelting furnace and/or from the second smelting furnace to the first smelting furnace.

9. The smelting furnace arrangement according to claim 8, wherein the solid material comprises dust.

10. The smelting furnace arrangement according to claim 1, wherein the arrangement comprises feeding means for feeding fluxing agents, solidified matte, solidified slag and/or material to be reverted to the first and/or the second smelting furnace, wherein the feeding means is the same for the first and the second smelting furnaces.

11. A method for producing blister in a smelting furnace arrangement, comprising:
i. feeding concentrate to a first smelting furnace,
ii. forming matte in the first smelting furnace,
iii. transporting at least a part of the matte from the first smelting furnace to a second smelting furnace via a second transport means, and
iv. forming blister in the second smelting furnace, wherein the first and second smelting furnaces comprise a reaction shaft end comprising a reaction shaft end wall and an uptake shaft end comprising an uptake shaft end wall, wherein the reaction shaft end wall of the first smelting furnace is located at a distance from the reaction shaft end wall of the second smelting furnace, and wherein the distance is less than 20 m.

12. The method according to claim 11, wherein the first smelting furnace is a suspension smelting furnace and/or wherein the second smelting furnace is a suspension smelting furnace.

13. The method according to claim 11, wherein the matte comprises iron and copper sulphides.

14. The method according to claim 11, wherein the method further comprises v. transporting slag from the second smelting furnace to the first smelting furnace, preferably wherein the slag is transported as a melt via a first transport means.

15. The method according to claim 14, wherein the slag comprises copper oxides, iron oxides and fluxing agents.

16. The method according to claim 11, wherein the method further comprises vi. transporting solids from the second smelting furnace to the first smelting furnace and/or from the first smelting furnace to the second smelting furnace, wherein the solids are transported via solid transport means.

17. The method according to claim 16, wherein the solids comprise dust.

18. The method according to claim 11, wherein the blister comprises copper blister.

19. The method according to claim 11, wherein the method further comprises feeding fluxing agents, solidified matte, solidified slag and/or material to be reverted to the first and/or the second smelting furnace through feeding means, wherein the feeding means is the same for the first and the second smelting furnaces.
